(19) United States
(12) Patent Application Publication
(10) Pub. No.: US 2015/0312069 A1
(43) Pub. Date: Oct. 29, 2015

(54) ELECTRICAL APPARATUS FOR TRANSMITTING ELECTRICAL ENERGY IN A CLOCKED MANNER

(71) Applicant: ELMOS SEMICONDUCTOR AG, Dortmund (DE)

(72) Inventors: Andre Sudhaus, Dortmund (DE); Petrus Johannes Devilee, Dortmund (DE)

(73) Assignee: ELMOS Semiconductor AG, Dortmund (DE)

(21) Appl. No.: 14/441,523

(22) PCT Filed: Nov. 4, 2013
(86) PCT No.: PCT/EP2013/072918

§ 371 Date: May 8, 2015

(30) Foreign Application Priority Data
Nov. 8, 2012 (EP) 12191816.3

(51) Int. Cl. H04L 25/49

(52) U.S. Cl. CPC H04L 25/4902

(57) ABSTRACT

The electrical apparatus (10) for transmitting electrical energy in a clocked manner or with clocked transmission of electrical energy is provided with an input (32) and also an output (34) and a docked switch (26) which is connected between the input (32) and the output (34). The apparatus (10) further has a drive unit (28) for docking the switch (26) by pulse-width modulation with a fundamental frequency at which drive pulses (38) follow one another. The pulse-width modulation can be operated by periodic clocking during in each case only one drive pulse group comprising a variable, predefinable number of successive drive pulses (38) or drive intervals and therefore at a subharmonic of the fundamental frequency, wherein the minimum permissible minimum number and the maximum permissible maximum number of drive pulses (38) or intervals in the drive pulse group are selected to the exclusion of subharmonics which lie within predefinable subfrequency bands which are below the fundamental frequency.

The present application claims the priority of European Patent Application EP 12 191 816.3 of Nov. 8, 2012, the content of which is herewith included into the subject matter of the present patent application by reference.

The invention relates to electrical systems such as e.g. electrical apparatuses which are operative to transmit electrical energy in a docked manner from an input to an output.

Such apparatuses are known e.g. as switching regulators for control circuits or e.g. for transformation of direct voltages (see e.g. US-A-2008/0175029 and US-A-2012/0250378). In electrical apparatuses of the switching type, docked transmission of electrical energy is performed using a temporary storage device (typically in the form of a capacitor) which can be loaded and unloaded in a docked manner.

The progressively required miniaturization of electrical apparatuses of the switching type makes it imperative to use ever smaller component parts, entailing the need to increase the switching and respectively fundamental frequency at which the system is run. Thus, these fundamental frequencies are above specific frequency bands within which the docked system is not allowed to emit electro-magnetic radiation. This can be prevented e.g. by constructional and circuit-related measures or can at least be attenuated in accordance with the EMC regulations, which, however, will in each case lead to additional expenditure.

It is an object of the invention to provide a switching-type or clocked electrical apparatus which is provided with simplified possibilities for preventing/reducing the power emitted within a predefinable frequency band.

In accordance with the invention, the above object is achieved by an electrical apparatus for transmitting electrical energy in a docked manner or with docked transmission of electrical energy, wherein said device is provided with
an input and an output,
a clocked switch connected between the input and the output, and
a drive unit for clocking the switch by pulse width modulation or pulse density modulation with a fundamental frequency at which drive pulses follow one another.

Herein, it is provided in accordance with the invention
that the pulse width modulation can be operated by periodic clocking during in each case only one drive pulse group comprising a variable, predefinable number of successive drive pulses and/or drive intervals and therefore at a subharmonic of the fundamental frequency, and
that the minimum permissible minimum number and the maximum permissible maximum number of the drive pulses in the drive pulse group and/or drive intervals in the drive interval group are selected to the exclusion of subharmonics which lie within predefinable subfrequency bands which are below the fundamental frequency.

Expressed in a general sense and in summary, the invention proposes that, in an electrical system which is clocked/switched at a rather high fundamental frequency, when the system is operated in the partial load range, the subharmonics of the fundamental frequency will be controlled by pulse packet modulation. By this driving by means of merely pulse packets, i.e. drive pulse groups and/or drive pulse intervals (burst) with a specific number of drive pulses, the resultant subharmonic(s) occurring in the frequency spectrum can be influenced by corresponding selection of the number of the pulses of the pulse packets. In a certain way, the pulse packet modulation which according to the invention is provided in the partial load operation, can be equated with a pulse density modulation.

As examples of possible applications of the invention, there can be mentioned switching regulators for the most different purposes such as e.g. for voltage generation (DC/DC converter). Further, mention should be made of a step-up converter (boost converter), a step-down converter (buck converter), a SEPIC and a Cuk converter.

For instance, the invention makes it possible, in a switched electrical system which is operated with pulse width modulation and at a fundamental frequency of a few MHz, to select the number of pulses in pulse packet modulation in such a manner that the system will not radiate e.g. in the AM band and not in an acoustically perceivable manner. Acoustically perceivable noises can be caused by mechanical properties due to electrical excitation of the electrical components such as e.g. of the capacitor which normally is required for temporary storage of electrical energy, or of the inductance. By way of preliminary analyses, i.e. for example simulation or empirical research, there can be detected those numerical ranges for the number of pulses for pulse packet modulation which are allowable under the aspect of avoiding/suppressing/attenuating a power emission in the respective predetermined frequency bands or individual frequencies that are to be excluded, and which are permitted for partial-load operation of the switchable electrical apparatus.

According to an advantageous embodiment of the invention, it can be provided that the electrical apparatus comprises a store (e.g. consisting of an inductance and/or a capacitance) for temporary storage of electrical energy for transformation of an input direct voltage applied at the input terminal into an output direct voltage at the output terminal, the switch being adapted to be switched on and off in a clocked manner for loading the store and for unloading the store for the purpose of transmitting the stored electrical energy to the output. The clocked switch is arranged at the respective position—as provided for the specific electrical circuit—between the input and the output of the electrical apparatus and, in this embodiment of the invention, serves for alternate loading and unloading of a store which can be e.g. a capacitor. Also further circuit-related components, such as e.g. inductances and freewheeling diodes, can be integrated into the electrical circuit, which, however, is per se generally known in electrical circuits.

Thus, the principal features of the apparatus according to the invention can be summarized as follows:
control over the radiation of electromagnetic waves of switchable systems such as e.g. switching regulators by controlled pulse packet modulation (e.g. when applied in voltage generation by a switching regulator);
use of a fixed or frequency-modulated fundamental frequency e.g. for energy transmission in switching regulators, which e.g. allows for a dimensioning of external components;
avoidance of emissions in predefinable specific frequency bands, e.g. in the amplitude modulation band for radio reception in automobile radios, inter alia and particularly in case of non-continuous switching operation;
avoidance of acoustic emissions generated e.g. by mechanical properties of intermittently controlled electronic components such as e.g. capacitors;
use of a pulse density function for modulation of the output power of the electrical apparatus, wherein this output power, although not necessarily so, can be further generated with variable frequency;
formation of an envelope of the switching processes (clocking) by application of marginal conditions such as
   minimal activation times,
   minimal deactivation times and
   maximal cycle length;
reduction of emission peaks by selective and particularly variable application/use of at least one of the above mentioned marginal conditions.

The invention will be explained in greater detail hereunder by way of an exemplary embodiment and with reference to the drawing. In the individual figures, the following is shown:

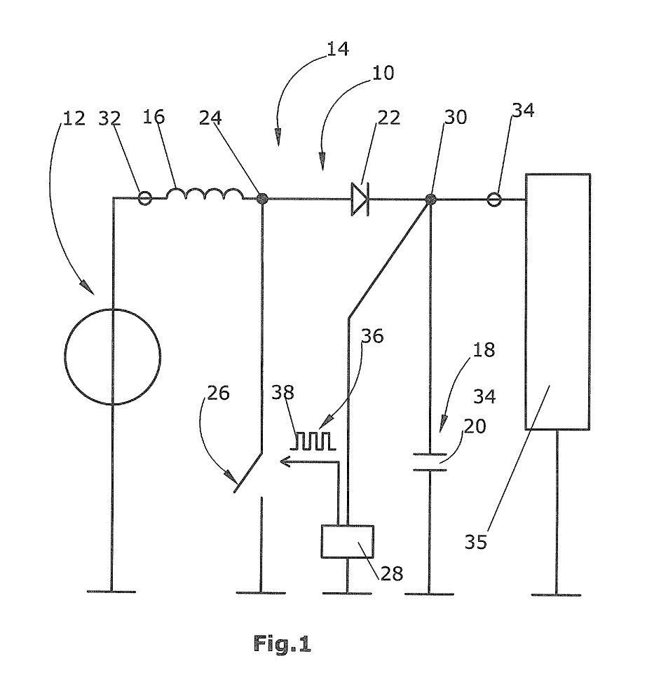

FIG. 1 is an exemplary and schematic circuit diagram of an electrical system of the switching type in the form of a DC/DC voltage converter for a vehicle, and

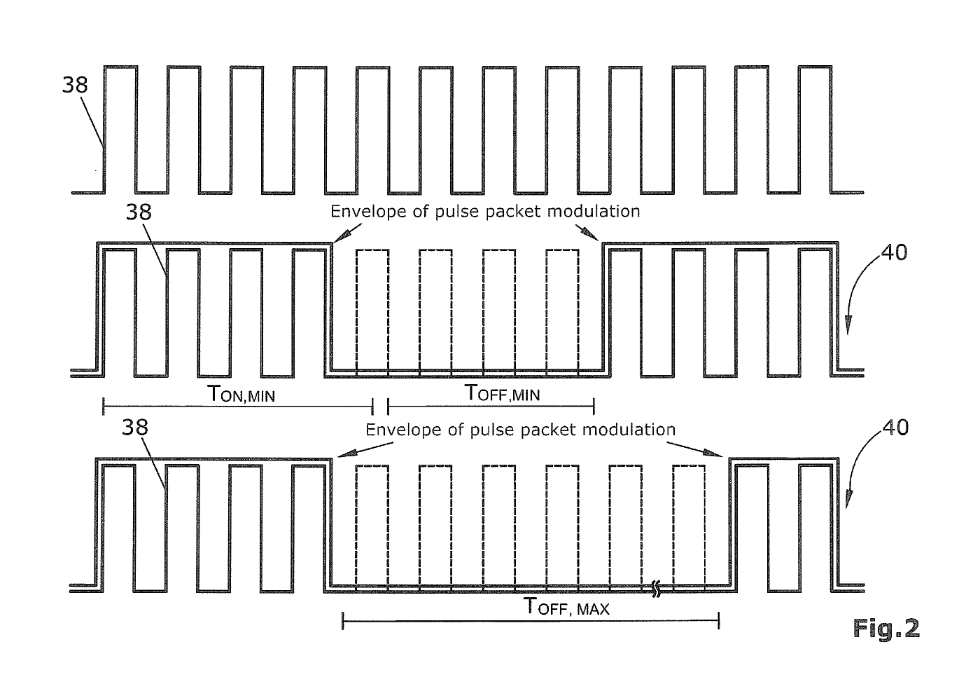

FIG. 2 is a schematic representation of the concept of the pulse packet modulation in partial load operation in contrast to the otherwise occurring pulse width modulation in normal operation of the system of the switching type according to FIG. 1.

In FIG. 1, there is shown an electrical apparatus 10 in the form of a circuit which in this embodiment is a direct voltage converter (DC/DC voltage converter) operated e.g. from the on-board network of a vehicle. The voltage supply 12 is thus realized by the on-board network, wherein the apparatus 10 comprises an LC element 14 having an inductance 16 connected to a V-on-board network (V_{BN}) and a capacitance 18, connected to ground, in the form of a capacitor 20 storing electrical energy. Between inductance 16 and capacitance 18, a freewheeling diode 22 is connected, wherein the node 24 between freewheeling diode 22 and inductance 16 is alternately connectable to ground with the aid of a switch 26 which is operable in a docked manner. Said switch 26 is controlled by a switch regulator (generally a drive unit 28) which at its input receives the output voltage applied between freewheeling diode 22 and capacitance 18 (see node 30). While, thus, the input 32 of apparatus 10 has the supply voltage V_{BN} applied to it, the apparatus 10 will at its output 34 supply an output voltage controlled by drive unit 28 for operation of a consumer 35.

Drive unit 28 generates a pulse-width-modulated drive signal in the form of a drive pulse sequence 36 which consists of a sequence of pulses 38 that can be modulated in their width.

Circuit concepts of the type as described above and shown in FIG. 1 are basically known.

The special characteristic of apparatus 10 is to be seen in the ability to switch the driving of switch 26 in special phases of the operation of apparatus 10, e.g. in partial load operation. This is illustrated e.g. in FIG. 2. The topmost diagram in FIG. 2 shows the uninterrupted drive pulse sequence 36 at normal operation in the form of a PWM (pulse with modulation).

The diagram in the middle and at the bottom in FIG. 2 illustrate the characteristic features of the invention and of the driving in partial load operation. In this case, pulse packets having a predefinable length and a predefinable number of drive pulses are blanked out and, respectively, the driving of switch 26 will still be performed merely in the remaining time periods in the form of pulse packets 40 in which the drive pulses 38 will be applied to the switch 26. Thereby, switch 26 is supplied with drive pulses 38 not anymore at the fundamental frequency determined by pulse width modulation but at a subharmonic of the fundamental frequency. By the selection of the minimum permissible minimum activation time (T_{ON,MIN}), the minimum permissible minimum deactivation time (T_{OFF,MIN}), the maximum permissible maximum deactivation time (T_{OFF,MAX}) and the maximum permissible maximum cycle length (T_{PERIOD,MAX}), it is possible to selectively exclude subfrequency bands and individual subfrequencies below the fundamental frequency, so that, in these ranges of the frequency spectrum, the switching regulator 28 and the entire apparatus 10 will not radiate at all or only at a reduced extent. For instance, it is made possible in this manner, at a fundamental frequency in the MHz range, to exclude the emission spectrum in the AM range. Likewise, one can exclude the frequency range that is still acoustically perceivable.

In other words, it is thus rendered possible by the invention, with respect to the number of drive pulses 38 per pulse packet 40, to determine the minimum number and the maximum number of drive pulses 38 and, conversely, to define these limiting values per blanked-out pulse packet.

Thus, by the concept of the invention, systems clocked at high frequency and respectively maximum frequency can be modulated in such a manner that, in predefinable subharmonic frequency bands, the system will radiate no or only reduced electromagnetic or acoustic emission, wherein this concept can be realized without complex constructive/circuit-related EMC measures.

### LIST OF REFERENCE NUMERALS

10 apparatus
12 voltage supply
14 LC element
16 inductance
18 capacitance
20 capacitor
22 freewheeling diode
24 node
26 switch
28 drive unit (switching regulator)
30 node
32 input
34 output
35 consumer
36 drive pulse sequence (drive signal)
38 drive pulses
40 pulse packet

1. An electrical apparatus for transmitting electrical energy in a clocked manner or with docked transmission of electrical energy, comprising
an input and an output,
a clocked switch connected between the input and the output, and
a drive unit for clocking the switch by pulse width modulation or pulse density modulation with a fundamental frequency at which drive pulses follow one another,
wherein
that the pulse width modulation can be operated by periodic clocking during in each case only one drive pulse group comprising a variable, predefinable number of successive drive pulses or drive intervals and therefore at a subharmonic of the fundamental frequency, and
that the minimum permissible minimum number and the maximum permissible maximum number of drive pulses or drive intervals in the drive pulse group are selected to the exclusion or with reduction of subharmonics which lie within predefinable subfrequency bands which are below the fundamental frequency.

2. The electrical apparatus according to claim 1, comprising a store for temporary storage of electrical energy for transformation of an input direct voltage applied at the input terminal into an output direct voltage at the output terminal, the switch being adapted to be switched on and off in a clocked manner for loading the store and for unloading the store for the purpose of transmitting the stored electrical energy to the output.

3. The electrical apparatus according to claim 2, comprising a serial circuit comprising an inductance, a capacitance and a freewheeling electrode connected therebetween, the switch being arranged parallel to the serial circuit comprising the freewheeling electrode and the capacitance.

4. The electrical apparatus according to claim 2, comprising a serial circuit comprising an inductance, a capacitance and a freewheeling electrode.
